(19) United States
(12) Patent Application Publication
(10) Pub. No.: US 2023/0275767 A1
(43) Pub. Date: Aug. 31, 2023

(54) Control System for Technical Plants Having Certificate Management

(71) Applicant: Siemens Aktiengesellschaft, Muenchen (DE)

(72) Inventors: Benjamin LUTZ, Pfinztal (DE); Anna PALMIN, Karlsruhe (DE)

(21) Appl. No.: 17/863,035

(22) PCT Filed: Jan. 13, 2021
(86) PCT No.: PCT/EP2021/050560

§ 371 Date: Jul. 12, 2022

(30) Foreign Application Priority Data
Jan. 14, 2020 (EP) 20151788

(51) Int. Cl. H04L 9/32; G05B 19/418

(52) U.S. Cl. CPC H04L 9/3268; G05B 19/4185

(57) ABSTRACT

A control system for a technical plant, in particular a manufacturing or processing plant, wherein the control system is configured to initiate the issuance and revocation of certificates for components of the technical plant as part of certificate management, where the control system includes a computer-implemented revocation service which is configured to initiate the revocation of certificates in an event-controlled and automated manner.

### CROSS-REFERENCE TO RELATED APPLICATIONS

This is a U.S. national stage of application No. PCT/EP2021/050560 filed 13 Jan. 2021. Priority is claimed on European Application No. 20151788.5 filed 14 Jan. 2020, the content of which is incorporated herein by reference in its entirety.

### BACKGROUND OF THE INVENTION

### 1. Field of the Invention

The invention relates to a method and a control system for a technical installation, in particular a manufacturing or process installation, which, as part of certificate management, is configured to initiate an issuance and a revocation of certificates for components of the technical installation.

### 2. Description of the Related Art

As part of certificate management of an industrial installation, it must be possible not only to issue certificates but also to revoke them. The revocation of the certificates used by an installation component is performed in particular during decommissioning of the installation components and during their exchange (or replacement by another component) and can occur at runtime of the installation. Here, the certificates used are made invalid by the revocation. Otherwise, they could possibly be misused by, e.g., a written-off and disassembled device being employed for communication using these certificates (possibly in another installation section).

Also in the context of a modular automation, the possibility of being able to activate the revocation of specific certificates (if required) is indispensable. This is due to the ability to combine a module in various projects with various other modules and in the process generally being assigned project-specific certificates, which it requires for the communication with other modules in the respective project context. As soon as the use of a module is no longer required in a specific project context (and is thus to be prevented), all project-specific certificates assigned to the module in this project context are to be revoked in order to rule out misuse of the certificates.

With the revocation of the certificates which, depending on the scenario, can be activated by an installation component itself or by an authorized (administrative) body, a revocation request is distributed to a certification authority (CA), which has issued this certificate. Revocation requests of this type are an integral part of known certificate management protocols, such as CMP according to RFC 4120 and are supported by the certification authorities, e.g., by as EJBCA/PrimeKey CA. For other certification authorities that support protocols which, in their scope have no revocation requests as a message type, the revocation can either be realized either manually, directly at the certification authority (e.g. by way of their web frontend), or by application (e.g., activated by a registration authority (RA)).

If a communication link between individual components of the installation is suddenly no longer necessary and, from a security perspective, is to be prevented due to the revocation of the certificates used, then revocation of the certificates is no longer possible “with immediate effect” with previously known control systems. A revocation process has to date been activated by a user directly at the certification authority or via another central body, such as a registration service. Here, the need to revoke a certificate is firstly identified and then the revocation manually activated. Here, significant delays can result between these two events for organizational and technical reasons.

### SUMMARY OF THE INVENTION

It is an object of the invention to provide a control system of a technical installation, which permits certificate management with a more efficient revocation of certificates.

This and other objects and advantages are achieved in accordance with the invention by a method and a control system for a technical installation that comprises a computer-implemented revocation service, which is configured to initiate the revocation of certificates in an event-controlled and automated manner.

In the present context, a control system is understood to mean a computer-aided technical system, which comprises functionalities for representing, operating and controlling a technical system, such as a manufacturing or production installation. In the present disclosure, the control system comprises sensors for determining measurement values, as well as various actuators. Additionally, the control system comprises what are known as process or manufacture-oriented components, which serve to activate the actuators or sensors. Furthermore, the control system has inter alia means for visualizing the technical installation and for engineering. The term control system is additionally intended to also encompass further computer units (including processors and memory) for more complex regulations and systems for data storage and processing.

The technical installation can be an installation from the process industry, such as a chemical, pharmaceutical or petrochemical installation, or an installation from the food and beverage industry. This also encompasses any installations from the production industry, factories, in which, for example, automobiles or goods of all kinds are produced. Technical installations that are suitable for implementing the method in accordance with the invention can also come from the power generation sector. The term “technical installation” also encompasses wind turbines, solar installations or power generation installations.

A component can be individual sensors or actuators of the technical installation. A component can, however, also be a combination of a number of sensors and/or actuators, such as a motor, a reactor, a pump or a valve system.

A certificate is understood to be a digital data record, which confirms certain properties (in this case of machines, devices, applications and the like). An authenticity and integrity of the certificate can, as a rule, be verified via cryptographic methods.

As a result of the revocation being activated in an event-controlled and fully automated manner by the process control system, the certificates to be revoked can be revoked with as immediate an effect as possible. On account of the technical features in accordance with the invention, delays in the revocation process can be efficiently minimized, which improves the certificate management of the control system of the technical installation overall.

Any changes in state within the technical installation are possible as an event. Within the scope of an advantageous embodiment of the invention, a change in communication links between individual components of the technical installation represents such an event.

Advantageously, the revocation service of the control system is configured to initiate the revocation of certificates because the revocation service provides a revocation request to a certification authority. Here, the revocation service is configured to monitor, or to allow monitoring of, the processing of the revocation request. This means that the revocation service either itself monitors, i.e., directly, or allows it to be monitored via a separate service, i.e., indirectly, in particular via a registration service.

The certification authority is also referred to as an “issuing CA (Certification Authority)”.

An issuing CA of this kind is generally always online and, based on incoming certificate requests, provides certificates for various applicants, which it signs with its own issuing CA certificate. The trustworthiness of the issuing CA is ensured by its own issuing CA certificate being signed by the certificate of a trustworthy root certification authority (also referred to as “root CA”), which is located in a secure environment. In this context, it should be noted that the root CA is offline for most of the time and is only activated or switched on—while observing the strongest security precautions—when it is to issue a certificate for an associated issuing CA. The root CA may also be located outside the technical installation.

Within the scope of monitoring the revocation request via the revocation service, in the case of a delayed processing of the revocation request, this can direct a new request to the certification authority (reference is made in this context to what is known as “polling”). This process is described for instance in the standard RFC 4210 (RFC=Request for Comments) in which the certificate management protocol (CMP) is specified.

With a particularly preferred embodiment of the invention, the control system is configured, after revocation of certificates, to make known the revocation within the control system, where the announcement is implemented in particular in the form of a blocklist. On account of the immediate revocation of certificates, as already mentioned previously, and the directly subsequent distribution of the message with respect to the revocation within the control system, all components of the technical installation are always up-to-date with respect to the awarded certificates, which significantly reduces the risk of certificates being misused. On account of the announcement, all revoked certificates in the installation context are always available.

If blocklists are used, the announcement of the revoked certificates can be performed via the certification authority. Such an entry into the blocklist can be signed digitally by the certification authority to guarantee the authenticity of the entry. This prevents inter alia the blocklist from being able to be updated by a user (e.g., project engineer) or an intelligent service itself, which reduces the risk of misuse.

With the installation-wide available blocklist, it is possible to control ad-hoc which certificates issued by a project-specific certification authority are permissible in a project-specific manner and which are not permissible. If a certificate proves to be unauthorized in the context of an (engineering) project, then a revocation procedure can therefore be activated as described previously.

It is also an object of the invention to provide a that comprises a) initiating an issuance of a certificate to a component of a technical installation via a control system of the technical installation and b) in response to a specific event, automatically initiating a revocation of the certificate via a computer-implemented revocation service of the control system of the technical installation.

With respect to the explanations relating to the method claim and the advantages associated therewith, reference is made to the above embodiments relating to the inventive control system.

Within the scope of an advantageous embodiment of the method in accordance with the invention, a change in the communication links between components of the technical installation represents an event which triggers the automated initiation of the revocation of the certificate.

The revocation service for initiating the revocation of certificates preferably provides a revocation request to a certification authority, where the revocation service monitors the processing of the revocation request.

After revocation of certificates, the revocation is particularly preferably made known within the control system, where the announcement occurs in particular in the form of a blocklist.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described properties, features and advantages of this invention and the manner in which these are achieved will now be made more clearly and distinctly intelligible in conjunction with the following description of the exemplary embodiment, which will be described in detail making reference to the drawings, in which:

FIG. 1 is schematic block diagram of a control system in accordance with the invention; and

FIG. 2 is a flowchart of the method in accordance with the invention.

### DETAILED DESCRIPTION OF THE EXEMPLARY EMBODIMENTS

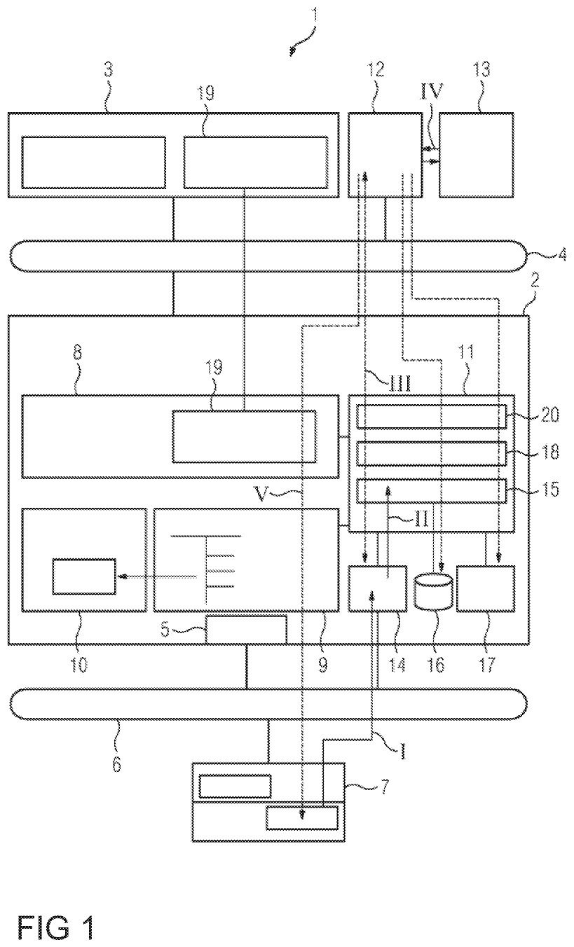

FIG. 1 shows part of a control system 1 in accordance with the invention of a technical installation formed as a process installation. The control system 1 comprises a server of an operator control system or an operator station server 2 and an operator station client 3 associated therewith. The operator station server 2 and the operator station client 3 are interconnected via a terminal bus 4 and are connected to further components (not shown) of the control system 1, such as an engineering system server or a process data archive.

In the context of operator control and monitoring, a user or operator has access to the operator station server 2 via the operator station server 3 over the terminal bus 4. The terminal bus 4 can be formed, without being limited thereto, as an industrial Ethernet, for instance.

The operator station server 2 has a device interface 5 that is connected to an installation bus 6. This can be used by the operator system server 2 to communicate with an (external) device 7. Here, the connected device 7 may alternatively also be an application, in particular a web application. In the context of the invention, any given number of devices and/or applications 7 may be connected to the operator station server 2. The installation bus 6 can be formed, without being limited thereto, as an industrial Ethernet, for instance. In turn, the device 7 may be connected to any number of subsystems (not shown).

Integrated in the operator station server 2 is a visualization service 8, via which a transmission of (visualization) data to the operator station client 3 can occur. The operator station server 2 also has a process image 9, a process data archive 10 and what is known as “user profile and selection service (UPSS)” 11. Recorded in the process image 9 of the operator station server 2 is a snapshot of the (signal) states of devices and/or applications 7 connected to the operator station server 2 via the device interface 5. Already past (signal) states are stored in the process data archive 10 for the purpose of archiving. The user profile and selection service 11 represents a database, in which user profiles and personal settings of operators/users of the process installation are recorded. These may also be accessible to further operators/users.

The control system 1 also comprises a registration authority 12 and a certification authority 13. These are connected to the operator station server 2 and the operator station client 3 via the terminal bus 4. The registration authority 12 is configured to accept and forward certification requests to the certification authority 13. The certification authority 13 is used to issue certificates.

If, in the context of a specific engineering project, a device 7 hopes to register with a control system 1 and use its functionalities, then the device 7 requires a valid certificate. In a first step I, the device 7 consults a certification service 14 of the operator station server 2. In a second step II, the certification service 14 accesses a blocklist 15 stored in the user profile and selection service 11. At the point of accessing the blocklist 15, in the context of the process installation, revoked certificates are stored in this blocklist 15 or in a database 16 of the user profile and selection service 11 (certificate revocation list).

If, in the context of the engineering project, the device 7 is entitled to the certificate to be requested, i.e., in particular the certificate is not cited in the blocklist 15 as a revoked certificate, then the corresponding certificate request is forwarded in a third step III to the registration authority 12, which in turn forwards the certificate request in a fourth step IV to the certification authority 13. The certificate issued by the certification authority 13 is then transferred via the registration authority 12 to the device 7 to be requested (step V).

If a specific event now occurs, such as a change in communication links within the process installation, then a specific certification may be invalid and must therefore be revoked. Based on a revocation service 17 of the operator station server 2, a revocation request is transmitted to the registration authority 12. The revocation request is activated here in a fully automated manner without any direct influence from a project engineer or operator of the process installation. The certification authority 13 subsequently invalidates the relevant certificate and stores this information on a blocklist 15 stored in the certification authority 13. The updated blocklist 15 is then transferred via the registration authority 12 to the database 16 of the user profile and selection service 11.

The event-controlled removal of the blocklist 15 by the registration authority 12 from the certification authority 13 can be realized here in different ways. In the simplest case, a trigger can be configured in the certification authority 13, which causes the blocklist 15 stored locally in the certification authority 13 to be immediately replaced by an updated blocklist 15 after revocation of a certificate. The storage location of the blocklist 15 in the certification authority 13 can be monitored by the registration authority 12 (e.g., via a corresponding intelligent service), so that each update can be identified immediately and the updated blocklist 15 can be transferred immediately to the user profile and selection service 11 of the operator station server 2. In order to increase the availability of the blocklist 15 when several operator station servers 2 are used, the database 16 can be aligned between the individual operator station servers 2 by means of a service “mirroring” 18.

An operator/project engineer can simulate new/revised events via an interface 19 mapped graphically on the operator station client 3 by the visualization service 8, said events being provided to the revocation service 17 for future automated revocations of certificates by means of a manage service 20 of the user profile and selection services 11.

Delays in the revocation process can be eliminated via the previously described technical features. Moreover, each device 7, in compliance with the minimality principle, which has a very high priority in the context of industrial security, exclusively obtains access to the current blocklist 15 which it actually requires. The technical functions required for this are integrated in a “process-related” manner in the control system 1 so that, in addition to the communication channels already available within the scope of the control system 1, no further communication channels are required for the revocation management “outside of the control system 1”.

With regard to security, a further advantage is that due to the required access to the blocklists 15 no specific settings have to be performed in the network (i.e., no ports have to be opened which entails a high security risk). The described control system 1 is well suited to modularized installations, in which dynamic process installation parts are added or removed.

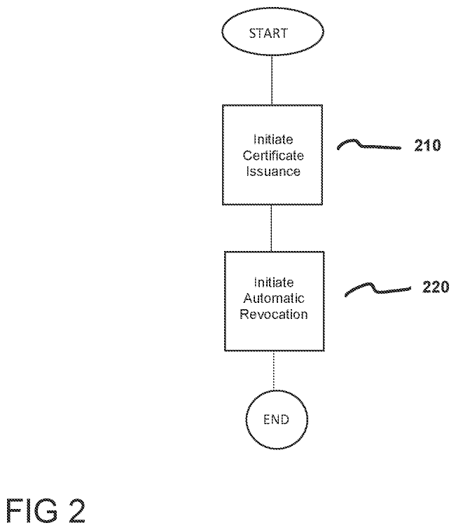

FIG. 2 is a flowchart of the method in accordance with the invention. The method comprises a) initiating an issuance of a certificate to a component of a technical installation via a control system 1 of the technical installation, as indicated in step 210.

Next, b) a revocation of the certificate via a computer implemented revocation service 17 of the control system 1 of the technical installation is automatically initiated in response to a specific event, as indicated in step 220. In accordance with the invention, a change in communication links between components 7 of the technical installation, without a component 7 being replaced or removed during a process, represents an event that triggers the automated initiation of the revocation of the certificate.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-6. (canceled)

7. A control system for a technical installation which is configured to initiate an issuance and a revocation of certificates for components of the technical installation within a context of a certificate management, the control system comprising:
a computer-implemented revocation service which is configured to initiate the revocation of certificates in an event-controlled and automated manner;
wherein a change in communication links between the components of the technical installation, without a component being replaced or removed during a process, represents an event which triggers the initiation of the revocation of certificates.

8. The control system as claimed in claim 7, wherein the revocation service is further configured to initiate the revocation of certificates; wherein the revocation service provides a revocation request to a certification authority; and wherein the revocation service is further configured to monitor, or allow monitoring of, the processing of the revocation request.

9. The control system as claimed in claim 7, wherein the control system is configured to make known the revocation within the control system after revocation of certificates; and wherein the announcement occurs formed as a blocklist.

10. The control system as claimed in claim 7, wherein the technical installation comprises a manufacturing or process installation.

11. A method, comprising:
a) initiating an issuance of a certificate to a component of a technical installation via a control system of the technical installation;
b) initiating automatically a revocation of the certificate via a computer-implemented revocation service of the control system of the technical installation in response to a specific event;
wherein a change in communication links between components of the technical installation, without a component being replaced or removed during a process, represents an event which triggers the automated initiation of the revocation of the certificate.

12. The method as claimed in claim 11, wherein the revocation service provides a revocation request to a certification authority to initiate the revocation of certificates; and wherein the revocation service monitors, or allows monitoring of, the processing of the revocation request.

13. The method as claimed in claim 11, wherein after a revocation of certificates, the revocation is made known within the control system; and wherein the announcement occurs formed as a blocklist.
